(19) United States
(12) Patent Application Publication
(10) Pub. No.: US 2005/0016341 A1
(43) Pub. Date: Jan. 27, 2005

(54) Apparatus and method for cutting book blocks to size

(75) Inventor: Mario Lorenzi, Villafranca-Padova (IT)

Correspondence Address: LERNER AND GREENBERG, PA, P O BOX 2480, HOLLYWOOD, FL, 33022-2480, US

(73) Assignee: Heidelberger Druckmaschinen Aktiengesellschaft

(21) Appl. No.: 10/837,267

(22) Filed: Apr. 30, 2004

(30) Foreign Application Priority Data
Apr. 30, 2003 (IT) MI2003 A 000875

(51) Int. Cl. B26D 1/00

(52) U.S. Cl. 83/13; 83/217; 83/534; 83/86

(57) ABSTRACT

An apparatus for trimming book blocks has at least a first lateral blade for performing a first lateral edge trim. The first lateral blade is attached to a movably mounted first lateral blade holder. A second lateral blade is provided for performing a second lateral edge trim. The second lateral blade is attached to a movably mounted second lateral blade holder. The blade holders have individual drives that are mechanically independent of one another.

### BACKGROUND OF THE INVENTION

### FIELD OF THE INVENTION

The invention relates to an apparatus for cutting book blocks to size. The apparatus has a movably mounted first lateral blade holder, and a first lateral blade for performing a first lateral edge trim. The first lateral blade is attached to the first lateral blade holder. A movably mounted second lateral blade holder is provided. A second lateral blade for performing a second lateral edge trim, is provided. The second lateral blade is attached to the second lateral blade holder.

An apparatus of the stated type is a cutting apparatus that is used in the bookbinding trade and contains three cutting blades, namely a front blade and two lateral blades. A triple cutter of this type is fed books via a feed station, the books already being bound at the spine, that is to say, for example, adhesively bound book blocks or stitched signatures which have been gathered on a gathering and stitching machine. The object of the triple cutter is to cut the books to a final desired format at the sides and at the front edge. Here, a distinction is essentially made between two cutting principles, namely cutting against a base and cutting against an opposing blade.

The drive for a triple cutter of this type contains a rotary electric motor running permanently at a constant rotational speed, for example a three-phase motor or DC motor having a flywheel, a common drive shaft which can be connected to the electric motor via a controllable clutch or clutch/brake combination, and a plurality of gear mechanisms with uniform or nonuniform transmission ratios, which gear mechanisms are all mechanically coupled to the common drive shaft.

Published, European Patent Application EP 0 740 983 discloses operating the lateral blades of a triple cutter independently of the front blade for the front trim. In order to have sufficient stability, the lateral blades are horizontally displaceably mounted on a common shaft and are therefore always operated simultaneously.

It is advantageous, however, in some applications if only one of the lateral blades cuts. In the apparatuses from the prior art this can only be achieved by dismantling the lateral blade that is not required and subsequently reinstalling and adjusting it. It should be noted here that the two lateral blades are oriented precisely with respect to one another, as both perform the same cutting movement. It would be desirable if this could be improved.

### SUMMARY OF THE INVENTION

It is accordingly an object of the invention to provide an apparatus and a method for cutting book blocks to size which overcome the above-mentioned disadvantages of the prior art devices and methods of this general type.

Accordingly, the apparatus according to the invention is an apparatus for trimming book blocks. The apparatus has at least one front blade for performing a front edge trim, the front blade is attached to a movably mounted front blade holder. The apparatus further has a first lateral blade for performing a first lateral edge trim. The first lateral blade is attached to a movably mounted first lateral blade holder. The apparatus has a second lateral blade for performing a second lateral edge trim, the second lateral blade being attached to a movably mounted second lateral blade holder. The blade holders have individual drives that are mechanically independent of one another. As a result, it is possible to switch off the drive of one of the lateral blades, so that trimming is performed using only one lateral blade, without it being necessary to make any further changes to the apparatus.

In a further advantageous embodiment, the apparatus according to the invention is an apparatus for trimming book blocks, the apparatus has at least one front blade for performing a front edge trim, the front blade being attached to a movably mounted front blade holder. The apparatus has a first lateral blade for performing a first lateral edge trim, and the first lateral blade is attached to a movably mounted first lateral blade holder. The apparatus further has a second lateral blade for performing a second lateral edge trim, the second lateral blade being attached to a movably mounted second lateral blade holder. The apparatus has at least one guide, by which the at least one blade holder is guided on both sides along its movement direction. The blade holder is advantageously one of the lateral blade holders, particularly advantageously all the blade holders of the apparatus according to the invention.

In apparatuses of the generic type from the prior art, in which the guide shaft is also moved, lateral guidance of the blades or blade holders cannot be accomplished on both sides, as the space necessary for this is required by the guide shaft during the movement. Guidance of the blade holders on both sides along the movement direction during cutting leads to particularly clean cuts. In the apparatuses of the generic type from the prior art, it is necessary, instead, to configure the guide shaft to be particularly thick and flexurally stiff, as a result of which the weight to be moved is disadvantageously very high. Guidance on both sides makes it correspondingly possible also to trim book blocks having thicknesses of up to 6 cm cleanly with a comparatively less powerful drive.

In an advantageous refinement of the apparatus according to the invention, the guide contains, on both sides, at least one guide face made of a wear-resistant material. In particular, the wear-resistant material is PET. No additional lubrication is necessary on account of the material properties of PET, as would be necessary, for example, in the case of bronze guides. As a result, the outlay on maintenance is reduced and a possible source of contamination of operator and book block is precluded. Alternatively, it is also possible to use other wear-resistant materials, as are known in large numbers to an expert in this field.

In an advantageous refinement of the apparatus according to the invention, at least one adjusting screw assigned to at least one guide face is provided, by which it is possible to change the position of the guide face in relation to the position of the blade holder. Advantageously, there are a plurality of adjusting screws which are advantageously disposed in such a way that the guide face can be set against the blade holder in an optimum manner.

In a further advantageous embodiment, the apparatus according to the invention is an apparatus for trimming book blocks. The apparatus has at least one front blade for performing a front edge trim, the front blade being attached to a movably mounted front blade holder. The apparatus has a first lateral blade for performing a first lateral edge trim, the first lateral blade being attached to a movably mounted first lateral blade holder. The apparatus further has a second lateral blade for performing a second lateral edge trim, the second lateral blade being attached to a movably mounted second lateral blade holder. The apparatus has a linkage mechanism, by which the blade holders are connected to a drive. The linkage mechanism contains a first coupler and a second coupler. The first coupler is connected to the blade holder, a blade holder housing and, eccentrically via a movable rod, to a drive pulley, and the second coupler is connected to the blade holder housing and the blade holder. In particular, the first coupler and the second coupler are configured in such a way that the distance between the point of contact between the blade holder housing and blade holder is different in the case of the first and second couplers. As a result, a swinging cut is automatically produced during the downward movement of the blade holder, in which cut the blade initially dips on one side of the book block but is then oriented parallel with respect to the base when it reaches the latter. As a result, a visually pleasing cut can be achieved, and the cutting forces arising at the beginning are reduced as a result, which reduces the loading on the drive, the blades and the associated mechanics and as a result increases the durability of the apparatus.

In an advantageous refinement of the apparatus according to the invention, the apparatus has a controller that is configured in such a way that it terminates the downward movement of the blade holder by reversing the drive when a predetermined cutting depth has been achieved. As a result, it is possible to vary the cutting depth by determining the instant at which the drive is reversed, in particular even when the blades are already installed. If, for example, an operator ascertains that the cutting depth is not sufficient or that cutting is being performed to an excessive depth into the base, then it is possible in a simple way to change the cutting depth by a change via the controller, for example by changing a prestress. If the apparatus according to the invention has individual drives for the individual lateral blades in this embodiment, the operator can easily change the cutting depth for each individual lateral blade separately, without it being necessary to dismantle the blades, which results in that the setting up process is made considerably easier and quicker.

In a further advantageous embodiment, the apparatus according to the invention is an apparatus for trimming book blocks. The apparatus has at least a first lateral blade for performing a first lateral edge trim, the first lateral blade being attached to a movably mounted first lateral blade holder, and a second lateral blade for performing a second lateral edge trim. The second lateral blade is attached to a movably mounted second lateral blade holder. The lateral blade holders are driven and mounted in such a way that it is possible to switch off the movement of at least one of the lateral blade holders by a controller. This can be achieved, for example, by providing individual drives for the lateral blades.

In a further advantageous embodiment, the apparatus according to the invention is an apparatus for trimming book blocks having at least a first lateral blade for performing a first lateral edge trim, the first lateral blade being attached to a movably mounted first lateral blade holder. The apparatus further has a second lateral blade for performing a second lateral edge trim, the second lateral blade is attached to a movably mounted second lateral blade holder. The first lateral edge trim and the second lateral edge trim are performed in parallel with respect to one another. The blade holders are movably fastened to blade holder housings, and the blade holder housings are mounted on two mutually parallel guide rods in a horizontally displaceable manner. The latter are fastened to the housing of the apparatus. The guide rods are, in particular, guide rods having a circular cross section. As a result, it is possible to achieve great stability for the whole frame of the apparatus. Moreover, the two-point mounting of the blade holder housing which is achieved as a result offers secure and stable guidance for the blade holders and thus also for the blades themselves, as a result of which it is in turn possible to achieve visually pleasing trimming of the book blocks.

In an advantageous refinement of the apparatus according to the invention, both lateral blade holder housings are mounted on the same two mutually parallel guide rods that are fastened to the housing of the apparatus. Advantageously, the apparatus has at least one drive, by which at least one of the blade holder housings can be displaced, together with the blade holder fastened to it, horizontally along the guide rods. Advantageously, it is even possible to move both blade holders with the drive, in particular symmetrically with respect to the center line of the apparatus.

In a further advantageous refinement of the apparatus according to the invention, parallel to at least one of the two parallel guide rods, the apparatus has a threaded spindle, by which the drive movement of the drive is converted into a horizontal movement of the blade holder housings.

In a further advantageous refinement of the apparatus according to the invention, the apparatus contains a controller that, in accordance with the dimensions of the trimmed book block, automatically changes the position of the lateral blade holder housings on the two parallel guide rods.

In an advantageous refinement of the apparatus according to the invention, at least one of the blade holder housings has a brake, by which it is possible to fix the at least one blade holder housing on at least one of the two mutually parallel guide rods. During cutting, considerable transverse forces occur in a perpendicular direction with respect to the cut. The brake makes it possible to decouple the loading during cutting from the spindle or another mechanism for laterally orienting the blade holders/blade holder housings. As a result, the expensive and sensitive components are protected from unnecessary wear. Accordingly, the apparatus advantageously has a controller which, by use of the brake, fixes the at least one blade holder housing on one of the two mutually parallel guide rods before the blade holders are moved vertically.

In a further advantageous embodiment, the apparatus according to the invention is an apparatus for trimming book blocks having at least a first lateral blade for performing a first lateral edge trim, the first lateral blade is attached to a movably mounted first lateral blade holder. The apparatus further has a second lateral blade for performing a second lateral edge trim, the second lateral blade is attached to a movably mounted second lateral blade holder. The first lateral edge trim and the second lateral edge trim are performed in parallel with respect to one another, and also have an apparatus for pressing down the lateral book block edges next to each lateral blade. The apparatus for pressing down the lateral book block edges has a pressing strip, and the apparatus for pressing down the book block edges are movably fastened to a lateral blade holder housing. Advantageously, it is thus possible to displace the apparatus for pressing down the book block edges horizontally together with the lateral blade holder housings. As a result, the hold-down is always at the same distance from the blade, so that it is possible to achieve constant cut quality independently of the format.

In an advantageous refinement of the apparatus according to the invention, the pressing strip has, at both ends, rods that are mounted vertically movably in guides and are also connected to a common cross-member in each case via toggle levers. Advantageously, the apparatus for pressing down the lateral book block edges has a drive, in particular a pneumatic drive, which drives the cross-member substantially horizontally, the substantially horizontal movement is converted by the toggle levers into a vertical movement of the pressing strip. As a result, the vertical guide becomes particularly stable, by the conversion of a horizontal movement into a vertical movement by the toggle levers, the toggle levers advantageously having a slot, in which the connecting element between the toggle lever and rod is fastened. As a result, it is possible to prevent harmful horizontal loadings of the rods and the bearings being produced. This has a positive effect on the durability of the components. Moreover, the cross-member ensures that the pressing strip is always moved in parallel with respect to the base of the book block. This is important as the book block does not necessarily have a constant thickness over the entire contact area with the pressing strip, for example because of nonuniform printing or because of the book spine.

In a further advantageous embodiment, the apparatus according to the invention is an apparatus for trimming book blocks and has at least a first lateral blade for performing a first lateral edge trim. The first lateral blade is attached to a movably mounted first lateral blade holder. The apparatus has a second lateral blade for performing a second lateral edge trim, the second lateral blade is attached to a movably mounted second lateral blade holder. The first lateral edge trim and the second lateral edge trim are performed in parallel with respect to one another. An apparatus for pressing down the book block surface between the lateral blades is provided. The apparatus for pressing down the book block surface has at least one drive, a push rod connected to the drive, and a press plate connected to the latter. The apparatus for pressing down the book block surface additionally has a transverse rod that is disposed vertically on the push rod and parallel to the lateral blades and has connecting elements by which the press plate latches releasably to the push rod. As a result, easy changing of the press plate and secure fastening are ensured, and rapid changing of the press plate during a format change is possible.

In an advantageous refinement of the apparatus according to the invention, the apparatus has an insertion aid for changing the press plate. The insertion aid has an insertion rail that is aligned with the transverse rod during the changing of the press plate. As a result, it is made considerably easier for an operator to perform a press plate change, in that he only has to hook the press plate into the insertion rail.

In an advantageous refinement of the apparatus according to the invention, the press plate has a coupling mechanism into which it is possible to couple an insertion rod. The coupling mechanism here is, for example, a thread into which it is possible to screw and unscrew the insertion rod.

In an advantageous refinement of the apparatus according to the invention, the apparatus has a magazine with press plates of varying dimensions. In particular, the apparatus advantageously has an automatic press plate changer.

In an advantageous refinement of the apparatus according to the invention, the underside of the press plate has connecting elements, by which it is possible to accommodate a press plate extension underneath the press plate, in particular an adhesive surface to hold a stiff board. In particular, the extended press plate is formed by a board that is cut to size with the same positional settings of the lateral blades for cutting the book block to size.

In an advantageous refinement of the apparatus according to the invention, the lateral blades are interchangeable. As a result, it is more cost effective to keep a supply of the blades and also to produce the blades. All three blades can particularly advantageously be interchanged. The blade holders advantageously have slots through which the blades are screwed onto the blade holders by screws.

The invention additionally relates to a method for attaching a blade to a blade holder in an apparatus for trimming book blocks. The method includes moving the blade holder into a blade change position above the zero position of the blade holder, loosely hooking the blade into the blade holder, lowering the blade holder into a zero position of the blade holder, lowering the blade onto the cutting base, the zero position of the blade, and fixing the blade in the zero position of the blade.

The great advantage of the method consists in that the blades are installed directly onto the blade holders in the apparatus and no further adjustment is required after the adjustment. The amount of adjustment work is particularly small for the operator in this method. The operator only has to loosely insert the blades into the holder, the exact adjustment occurs by lowering the blade holders onto the zero position, as a result of which the blades are advantageously pushed along slots into the optimum position. It is also thus possible, in particular, to quickly adjust resharpened blades and/or on worn bases, as the adjustment is predetermined by the inherent weight of the blades and the position of the base. The method according to the invention can be carried out particularly advantageously using an apparatus that has individual drives for each of the blades.

In a refinement of the method according to the invention, the method further includes correcting the zero position of the blade by displacing the zero position of the blade holder by control technology. The zero position advantageously corresponds to the point of drive reversal in accordance with the above-described embodiment of the apparatus according to the invention. It is therefore possible to readjust the blades in a matter of seconds, without having to make a mechanical intervention in the apparatus. Given suitable activation and a suitable drive, it is advantageously possible to set changes in the zero position by a few micrometers, so that the cutting depth can be resolved down below the thickness of one sheet.

In a refinement of the method according to the invention, the method additionally includes fastening change handles to the blade prior to performing the loosely hooking step. These change handles make it additionally easier for the operator to handle the blade. The change handles are removed again, for example unscrewed, from the blade before startup of the apparatus. While the blade is loosely inserted, there is a cover over the cutting edge for safety reasons, which is removed prior to the lowering into the zero position, after being loosely hooked into the blade holder. As a result, the risk of injuries from the blades is reduced.

In a refinement of the method according to the invention, the steps are performed repeatedly and individually for each blade of the apparatus. This is particularly relevant for the lateral blades, as it is now possible to adjust them individually.

Other features which are considered as characteristic for the invention are set forth in the appended claims.

Although the invention is illustrated and described herein as embodied in an apparatus and method for cutting book blocks to size, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1A is a diagrammatic representation of individual drives of an apparatus according to the invention;

FIG. 1B is a diagrammatic, side view of the apparatus with a transport path of book blocks;

FIG. 2A is a diagrammatic, side view of blade holder guides;

FIG. 2B is a diagrammatic, cross-sectional view of the blade holder guides;

FIG. 3A is a diagrammatic, side view of the blade holders and of a drive for the blade holders in a zero position;

FIG. 3B is a diagrammatic, side view of the blade holders and of the drive for the blade holders in a hooking-in position;

FIG. 3C is a diagrammatic, cross-sectional view through the blade holder and the drive for the blade holders in the zero position;

FIG. 4A is a diagrammatic, cross-sectional view through the horizontal displacement device of the blade holder housings and its drive;

FIG. 4B is a diagrammatic, side view of the horizontal displacement device of the blade holder housings and its drive;

FIG. 4C is a diagrammatic, plan view of the horizontal displacement device of the blade holder housings and its drive;

FIG. 5A is a diagrammatic, plan view of a brake of the blade holder housings;

FIG. 5B is a diagrammatic, cross-sectional view of the brake of the blade holder housings;

FIG. 6 is a diagrammatic, side view of a pressing strip and its drive;

FIG. 7A is a diagrammatic, cross-sectional view of the press plate and its drive and guide;

FIG. 7B is a diagrammatic, side view of the press plate, a press plate drive and guide, and also an insertion aid;

FIG. 7C is a diagrammatic, side view of the press plate with a handle screwed in; and

FIG. 7D is a diagrammatic, plan view of the press plate, the press plate drive and guide, and also the insertion aid and handle.

### DESCRIPTION OF THE PREFERRED EMBODIMENTS

The figures and their description are restricted to the elements that are essential to the invention. Furthermore, drive, guide and/or control devices and cam disks which are generally known and necessary to operate the apparatus are shown only diagrammatically or are described only in general form.

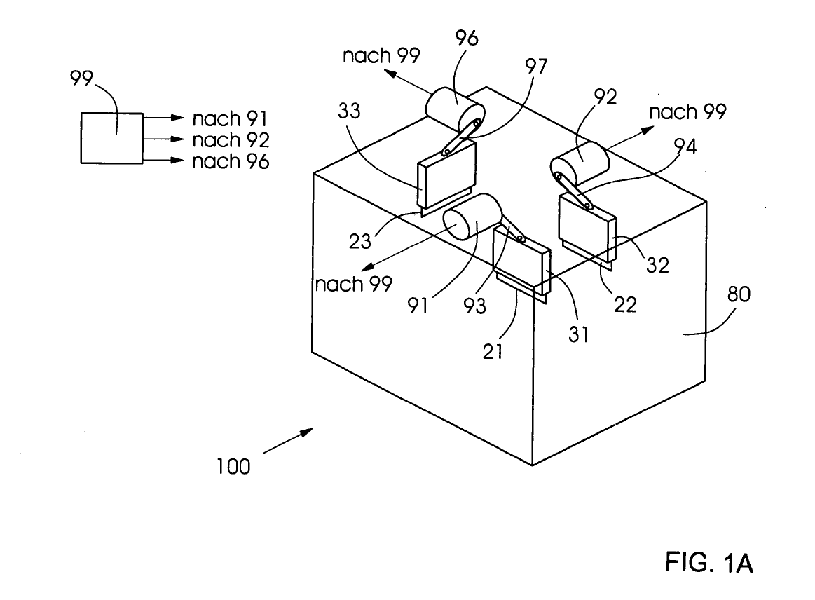

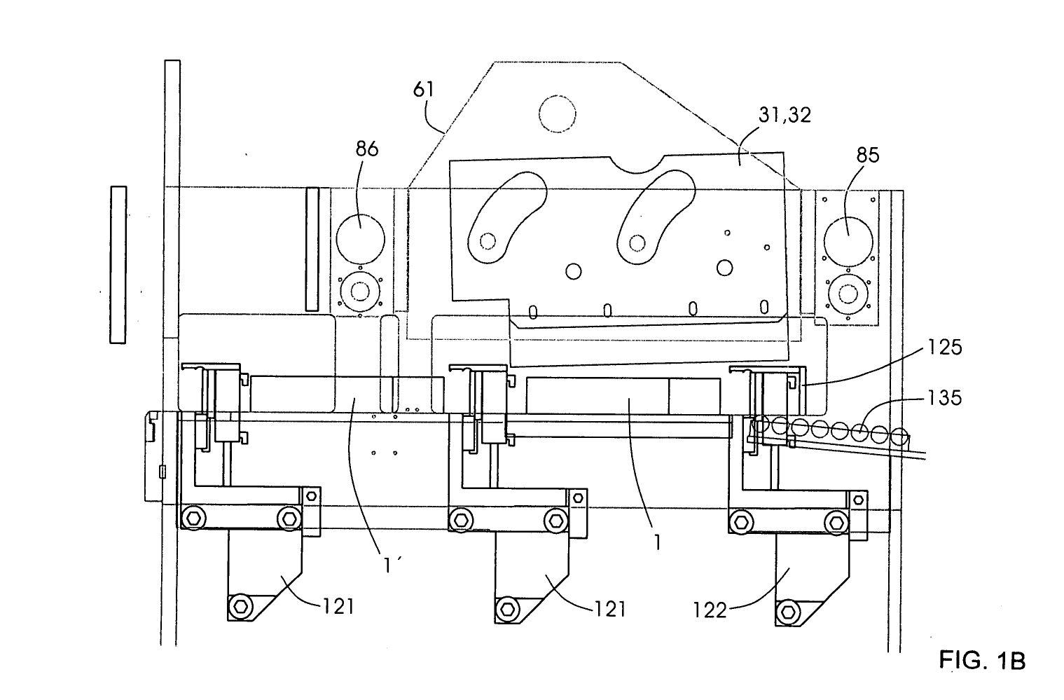

In all the figures of the drawing, sub-features and integral parts that correspond to one another bear the same reference symbol in each case. Referring now to the figures of the drawing in detail and first, particularly, to FIG. 1A thereof, there is shown a front blade holder 33 having an associated front blade 23 and two lateral blade holders 31, 32 having associated lateral blades 21, 22 and are disposed in a housing 80 of an apparatus 100. Each of the blade holders 31, 32, 33 is in each case assigned a drive 91, 92, 96 and is connected to a drive transmission element 93, 94, 97. A controller 99 activates the drives 91, 92, 96 to move the blade holders 31, 32, 33.

A book block 1 is initially moved, in a manner dependent on its format, into a first cutting position relative to the front blade 23. After a front edge trim has been performed, the book block 1 is moved into a second cutting position in relation to the two lateral blades 31, 32. After the lateral edge trim has been performed, the book block 1 is conveyed out of the apparatus 100.

In the side view shown in FIG. 1B, two grippers 121, 122 are shown which transport the book block 1 into a first cutting position, into a second cutting position and into the apparatus 100 and out of the apparatus 100. The first gripper 121 is shown twice in order to illustrate the cutting position. The position which the first gripper 121 assumes in FIG. 1B in the center is a transfer position in which the book block 1 which has been provided with a front edge trim, is transferred to the second gripper 122 in order to be moved into the second cutting position. The second gripper 122 has an ejection plate 125, with which the book block 1 can be pushed onto a delivery 135, while a book block 1′ is simultaneously drawn into the second cutting position.

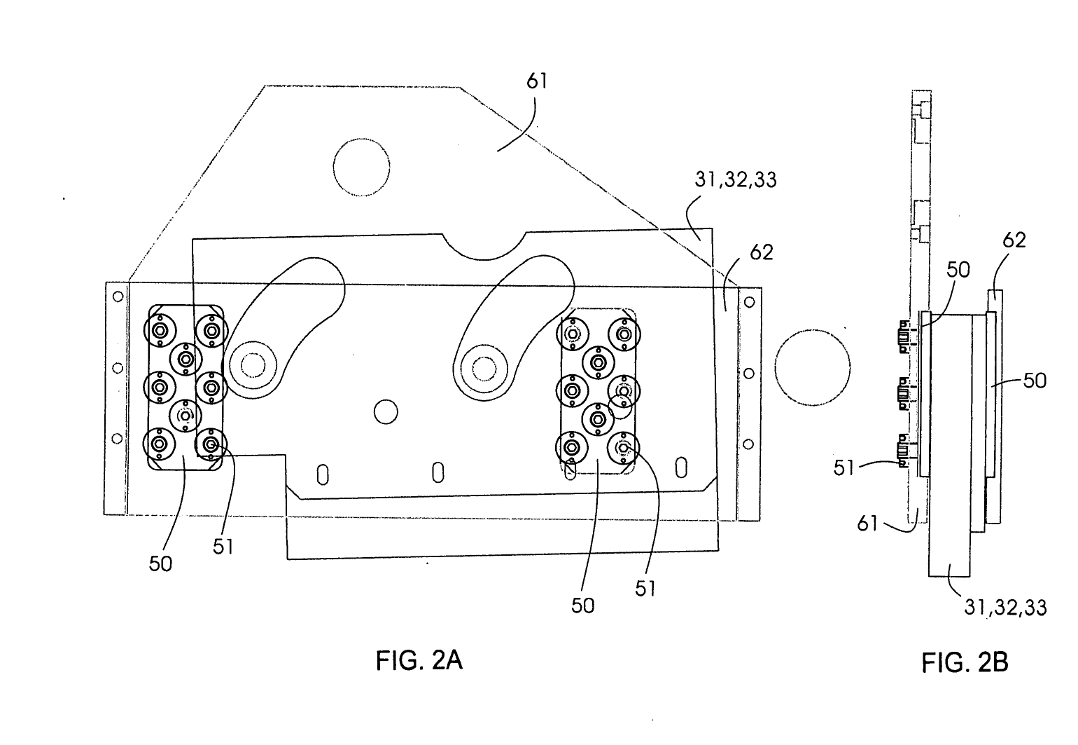

Parts of the blade holder 31, 32 of a lateral blade 21, 22 can likewise be seen in FIG. 1B. Further details of guides plates 50 are shown in FIGS. 2A and 2B. The blade holders 31, 32, 33 are moved within blade holder housings 61, 62 which are formed from a first blade holder housing plate 61 and a second blade holder housing plate 62 and also connecting elements between the blade holder housing plates 61, 62. The blade holders 31, 32, 33 are guided laterally by the guide plates 50 inside′ the blade holder housing plates 61, 62. In a preferred embodiment, the guide plates 50 are plates made of PET. The position of the guide plates 50 can be oriented by adjusting screws 51 which are provided at least on one side of the blade holders 31, 32, 33.

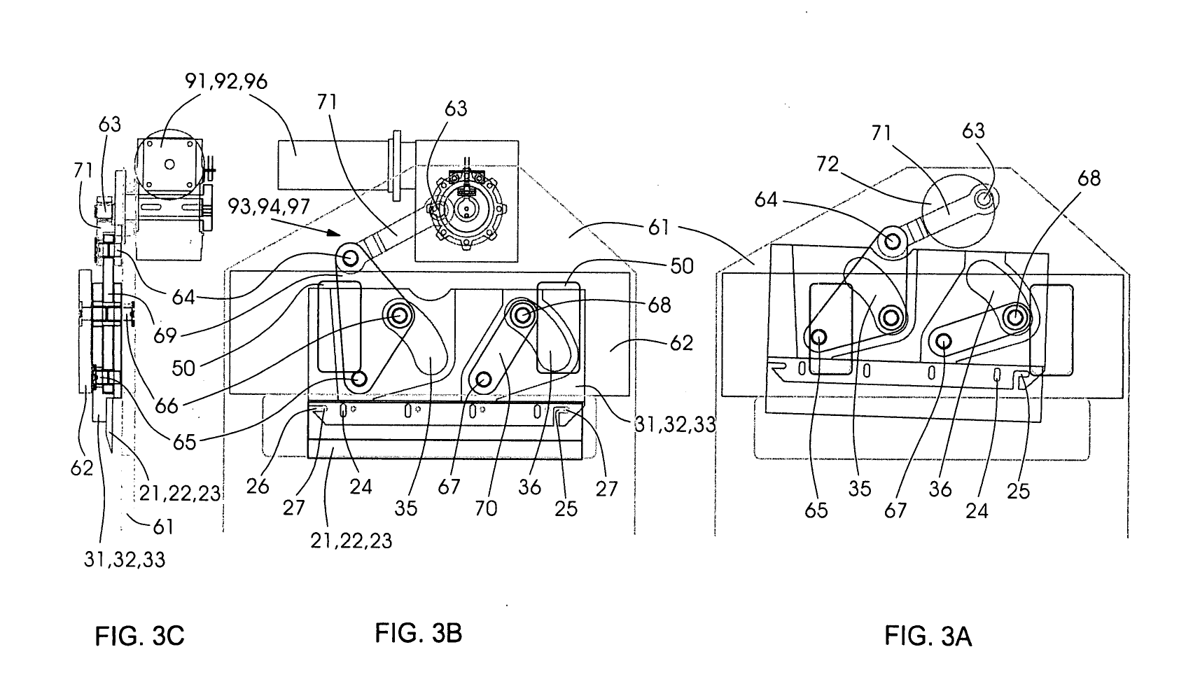

FIGS. 3A, 3B, 3C show an embodiment of the drive transmission elements 93, 94, 97. Here, FIG. 3B shows the blade holders 31, 32, 33 in a zero position of the blade 21, 22, 23, in which the blade 21, 22, 23 is lying in parallel contact with a cutting base. This also corresponds to a zero position of the blade holder 31, 32, 33. In FIG. 3A, in contrast, the blade holder 31, 32, 33 is shown in a raised position which serves for blade changing. The drive 91, 92, 96 for the blade holders 31, 32, 33 is configured, for example, as an electric motor which drives a drive pulley 72. A rod 71 is driven via a connecting element 63 that is fastened eccentrically to the drive pulley 72, the rod 71 being connected to a first coupler 69 via a connecting element 64. The first coupler 69 is connected to the first and second blade holder housing plates 61, 62 via a connecting element 66. The first coupler 69 is additionally rotatably connected to the blade holder 31, 32, 33 via the connecting element 65. A second coupler 70 is rotatably fastened to the first and second blade holder housing plates 61, 62 by a connecting element 68. At the other end, the second coupler 70 is rotatably fastened to the blade holder 31, 32, 33 by a connecting element 67. The first coupler 69 and the second coupler 70 are connected to the blade holder 31, 32, 33 and the blade holder housing plates 61, 62 in such a way that the lines between the connecting elements 65 and 66 of the first coupler and the connecting elements 67 and 68 of the second coupler are substantially parallel but the distance between the connecting elements 67 and 68 of the second coupler 70 is somewhat greater than the distance between the connecting elements 65 and 66 of the first coupler 69. The result of this is that, during a downward movement, the blade 21, 22, 23 is not moved parallel with respect to the cutting surface, but rather the blade 21, 22, 23 only has one contact point on the surface of the book block 1 during the cutting operation, the contact point running to the left over the book block 1 in the configurations shown in FIGS. 3A and 3B.

There are threaded bores 27 in the blade 21, 22, 23, into which threaded bores 27 non-illustrated hand grips can be screwed. In order to perform a blade change, the blade holder 31, 32, 33 is raised (as shown in FIG. 3A) and the hand grips are screwed into the threaded bore 27. A protective cap is fitted over the cutting edge, in order to prevent a risk of injury during the blade change. The screws with which the blades 21, 22, 23 are screwed to the blade holder 31, 32, 33 in the slots 24 are then loosened. After this, the blade 21, 22, 23 just hangs loosely on the hand grips, first in the L-shaped cutout 25 and second in the pocket-shaped cutout 26. As a result of the slight oblique position of the blade holder 31, 32, 33 in the blade change position in FIG. 3A, the inherent weight of the blades 21, 22, 23 presses the hand grips into the cutout 26, 27. The operator can remove the blade 21, 22, 23 from the blade holder 31, 32, 33 by lateral displacement by the hand grips, and loosely hang a new blade in the cutout 26, 27. Next, the screws for fastening the blade 21, 22, 23 to the blade holder 31, 32, 33 are loosely screwed into the blades 21, 22, 23 in threads aligned with the slots 24. After the hand grips are removed, the blade 21, 22, 23 thus hangs loosely on these screws. Subsequently, the drive 91, 92, 96 is activated by the controller 99 in such a way that the blade holder 31, 32, 33 moves into the zero position, after the blade protective device has been removed from the blade 21, 22, 23. The blade 21, 22, 23 rests on the cutting base in the zero position of the blade holder 31, 32, 33. Here, the screws for fixing the blade 21, 22, 23 to the blade holder 31, 32, 33 automatically assume their optimum position within the slots 24. In order to finish the blade change, all that is required is for the screws to be tightened in the slots 24 and therefore the blade 21, 22, 23 to be fixed on the blade holder 31, 32, 33.

The controller 99 activates the drives 91, 92, 96 in such a way that the drives 91, 92, 96 perform a drive reversal when the zero position of the blade holders 31, 32, 33 and therefore the zero position of the blades 21, 22, 23 is reached. As a result, it is possible to influence the location of the zero position by control technology. In order to lower the location of the zero position, that is to say to perform a deeper cut, all that is required is for the instant of drive reversal of the drives 91, 92, 96 to be selected to be later; the same is true in order to move the location of the zero position upward. Therefore, if an operator is not satisfied with the location of the zero position after the blade change, he can influence the appropriate drive 91, 92, 96 assigned to the blade 21, 22, 23 via the controller 99 in such a way that the zero position for the individual drive 91, 92, 96 is changed. These variations in the zero position can be made independently of one another as a result of the fact that all the blade holders 31, 32, 33 have their own drive 91, 92, 96. Mechanical readjustment of the blades is usually not at all necessary here, as the cutting edge of the blade 21, 22, 23 is substantially parallel to the cutting base in the vicinity of the zero position. Given an appropriately configured controller or an appropriately configured drive, it is possible in this way to vary the zero position of the blade holders 31, 32, 33 in the range of a few micrometers.

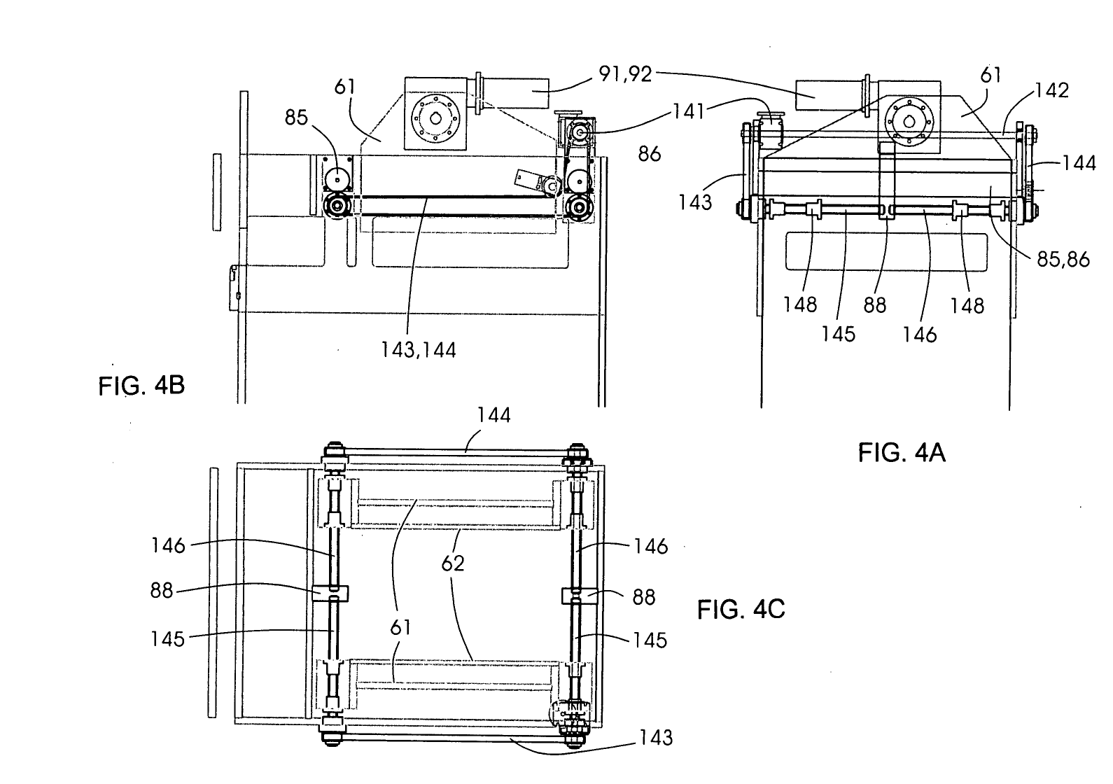

FIGS. 4A, 4B and 4C show the drive for the horizontal displacement of the lateral blades for adaptation to the format of the trimmed book block 1. The lateral blade holders 31, 32 are fastened in the blade holder housings 61, 62, as described. The blade holder housings 61, 62 are horizontally displaceably mounted on two thick guide rods 85, 86 together with the drives 91, 92 that are fastened to the first blade holder housing plate 61. The guide rods 85 and 86 are mounted in the housing 80 of the apparatus 100 according to the invention on both sides and, as a result, contribute considerably to the stability of the housing 80. A supporting element 88 is fitted halfway along the guide rods 85, 86. The supporting element 88 is likewise fastened to the housing 80 of the apparatus 100. Thanks to the supporting element 88, it is possible for the diameter of the guide rods 85, 86 to be comparatively small and nevertheless for sufficient stability of the housing and protection against deflection of the guide rods 85, 86 given the considerable forces which occur during cutting to be ensured.

Disposed parallel to and below the guide rods 85, 86 are in each case two threaded spindles 145, 146 which are mounted on one side in each case in the supporting element 88 and on the other side in the housing wall of the housing 80 of the apparatus 100. The blade holder housings 61, 62, mounted in threaded bushes 148, are attached to the threaded spindles 145, 146. A lateral blade adjusting drive 141 is connected to the threaded spindles 145 of the one lateral blade holder housing 61, 62 on one side of the housing 80 via a drive belt 143. The lateral blade adjusting drive 141 is connected to the threaded spindles 146 of the second lateral blade holder housing 61, 62 via a transmission shaft 142 and a drive belt 144. As a result, it becomes possible to displace the lateral blades, together with the lateral blade housings 61, 62, synchronously with respect to the center of the apparatus. The guidance on both sides by the guide rods 85, 86 of the blade holder housings 61, 62 ensures great stability of the system and therefore clean cuts.

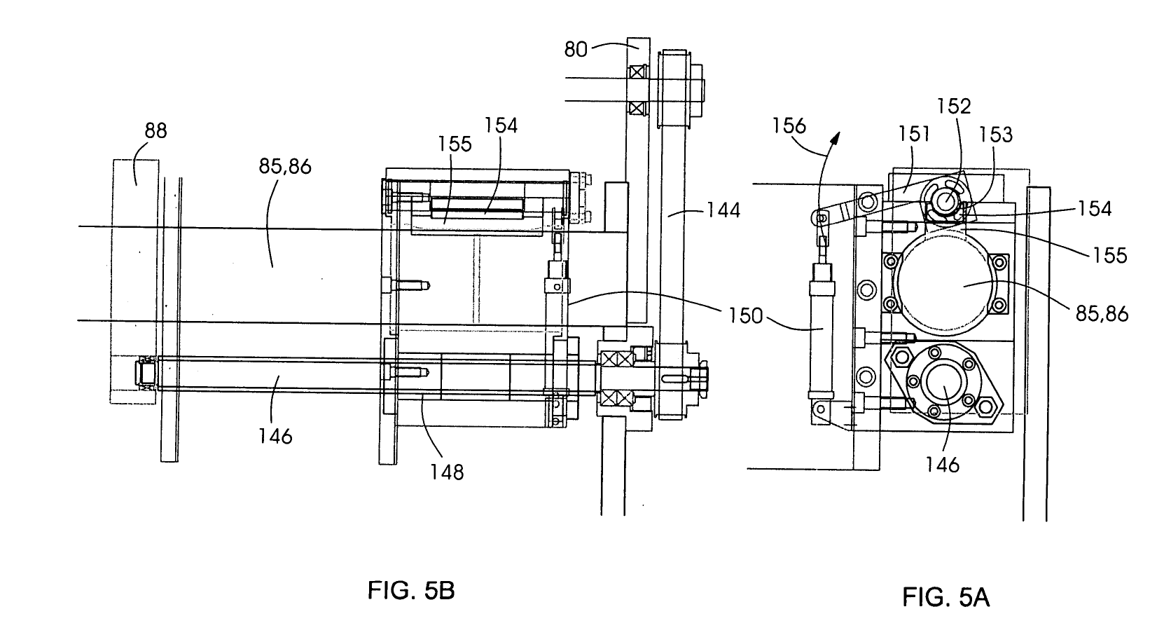

FIGS. 5A and 5B show a locking device with which it is possible to lock the blade holder housing 61, 62 on the guide rods 85, 86, before the cutting process is initiated. A brake actuating element 150 activates a brake lever 151 which rotates an eccentric shaft 152. An eccentric surface 153 is in contact with a contact block 154 which converts the change in radius when the brake lever 151 is rotated into a vertical movement and therefore moves a brake block 155 into contact with the surface of the guide rod 85, 86. As soon as the brake actuating element 150 has been moved in the movement direction identified by designation 156 and the blade holder housing 61, 62 has therefore been locked on the guide rod 85, 86, the threaded spindle 145, 146 is relieved of loading. Transverse forces which occur during cutting can no longer load the threaded spindles 145, 146 as a result, which has a positive effect on the durability of the threaded spindles 145, 146.

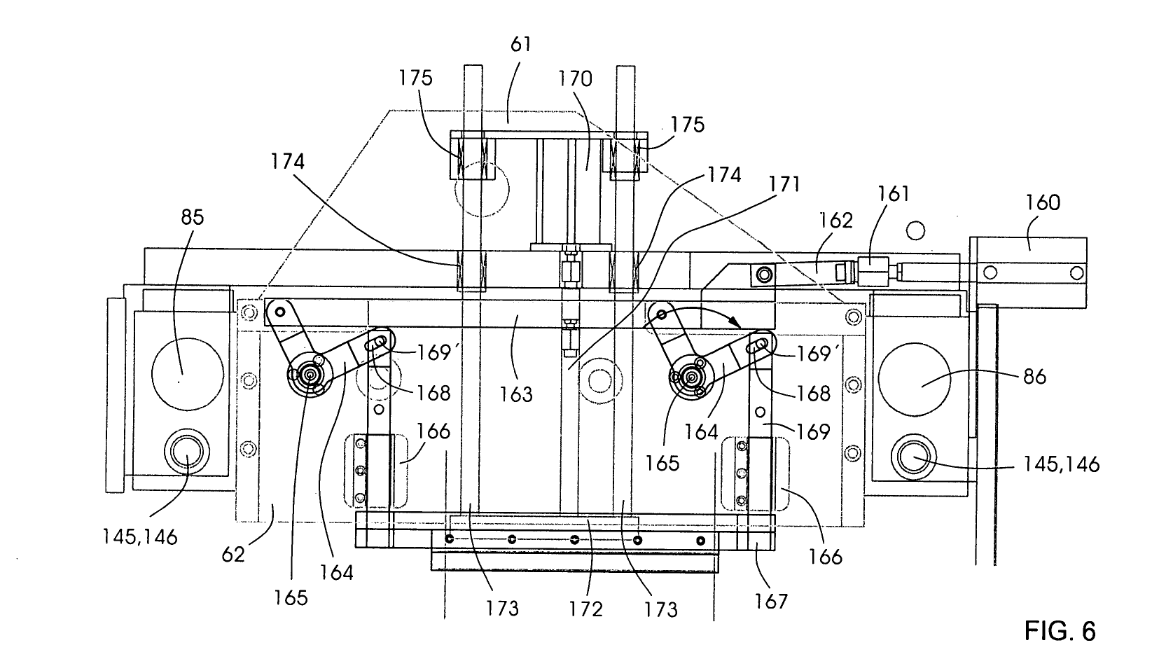

FIG. 6 shows an apparatus which presses the book block 1 down in the immediate vicinity of the blade tips 21, 22, 23, so that it is possible to perform a smooth lateral edge trim or front edge trim. The apparatus is advantageously provided for the front blade 23 and for the two lateral blades 21, 22. A pressing strip 167 is mounted in vertical guides 166 with two -pressing strip rods 169. Fitted to the end of the pressing strip rods 169 are drivers 169′ which are mounted in slots in toggle levers 164. The vertical guides 166 are screwed to the second blade holder housing plate 62. A toggle lever 164 is likewise connected to the second blade holder housing plate 62 at the toggle lever pivot point 165. Both toggle levers 164 are connected to a cross-member 163 that is connected, via a push rod extension 162, to the push rod 161 which is driven by the pressing strip drive 160. The pressing strip drive 160 is, for example, a pneumatic drive. If the pressing strip drive 160 is activated, both toggle levers 164 are rotated simultaneously via the cross-member 163, so that the pressing strip rods 169 press the pressing strip 167 vertically downward. The slots 168 suppress a horizontal movement component that would lead, for example, to damage to the bearings. The mechanical transmission of the pneumatic drive 160 achieves the situation where the pressing strip 167 is always moved parallel to the cutting surface and therefore all irregularities in the thickness of the book block 1 are eliminated.

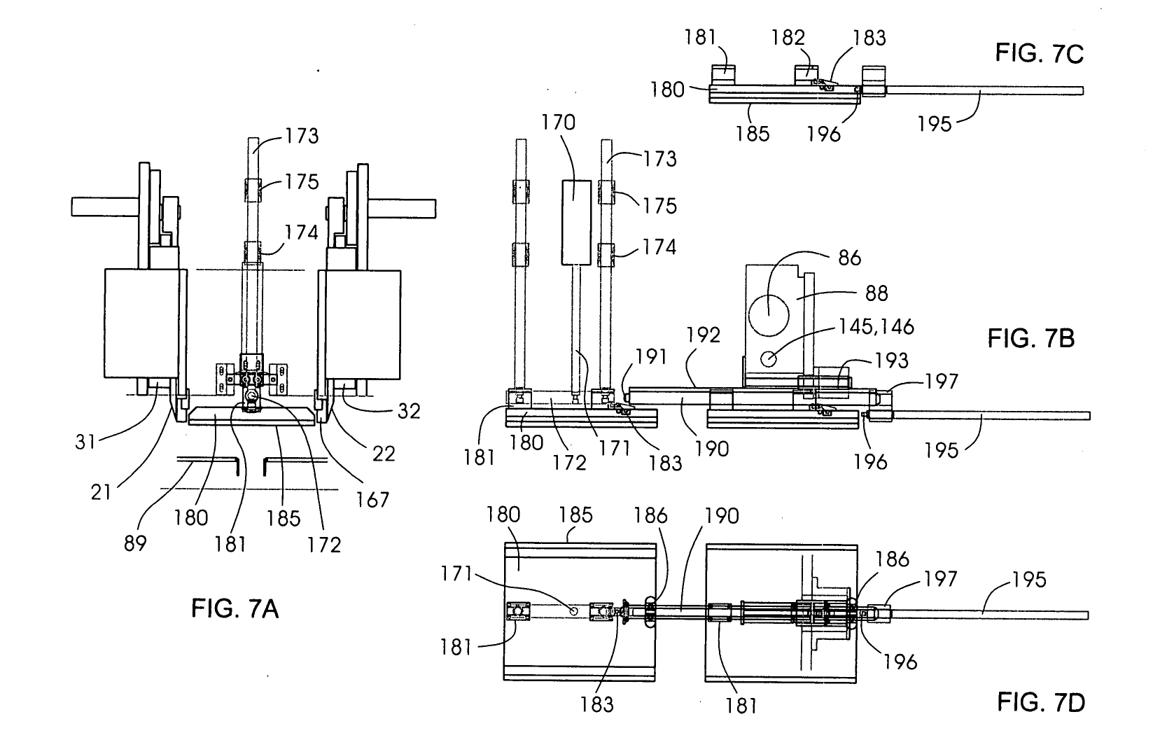

FIG. 6 likewise shows an apparatus for pressing the book block 1 down over its area, more details of the apparatus are shown in FIGS. 7A-7D. The apparatus serves to hold the book block 1 over a large area during the lateral trim and to press out the air from between the pages of the book block 1 prior to trimming. The apparatus contains two parts, first a mechanism fixed to the device for moving a press plate 180, and also the exchangeable press plate 180 itself. The mechanism fixed to the device contains a pressing face drive 170, for example a pneumatic cylinder, which drives a push rod 171. The push rod 171 is connected to a transverse rod 172. The transverse rod 172 in turn is connected to two pressing face guide rods 173 which are mounted in the first and second vertical guide 174, 175.

On its upper side, the press plate 180 has a front press plate connecting element 182 and a rear press plate connecting element 181 which can be inserted into the transverse rod 172. Provided in the region of the front press plate connecting element 182 is a latch 183 which latches into the transverse rod 172 when the desired position of the press plate 180 has been reached. Moreover, the press plate 180 has an internal thread 186 into which a thread 196 of a handle 195 can be screwed. The handle 195 has a handle guide 197 which is aligned with the front and rear press plate connecting element 181, 182.

In order for it to be possible to perform a clean lateral trim of the book block 1, it is necessary for the book block 1 to be pressed down as far as possible over its whole area. As the dimensions of the book blocks can usually vary from processing job to processing job, it is necessary for the press plate 180 to be exchanged in a manner dependent on the format. As the space above the book block 1 in the second cutting position for the lateral trim is usually not easily accessible, the apparatus 100 according to the invention has an insertion aid 190. The insertion aid 190 contains a rail that is connected to a supporting element 88 via an insertion aid guide 193. The insertion rod 190 slides along the insertion aid guide strip 192 and can be moved into alignment with the transverse rod 172 to change the press plate 180. The insertion rod 190 and the transverse rod 172 have the same cross section. In order, during the press plate change, to align the axes of the transverse rod 172 and the insertion aid 190, the insertion rod 190 has, at its end, a lug 191 that fits into the transverse rod 172. Once the insertion rod 190 and transverse rod 172 are aligned, the press plate 180 can be pushed onto the insertion rod 190 by the handle 195 and can be pushed as far as the transverse rod 172. The latch 183 is released by inserting the insertion rod 190 into the transverse rod 172. Once the insertion aid 190 has been removed from the transverse rod 172 again, the latch 183 automatically latches and thus fixes the press plate 180. As soon as the press plate 180 has latched onto the transverse rod 172, the handle 195 can be unscrewed and the insertion aid 190 can be moved away out of the region above the second cutting position.

In order to achieve optimum adaptation to the size of the book block 1, the press plate 180 can accommodate a press plate extension 185 on its underside. The press plate extension 185 can be, for example, a strong board that is first fastened to the underside of the press plate 180 and is then trimmed using the format settings for a lateral trim, which format settings correspond to the format settings for the subsequent book blocks.

This application claims the priority, under 35 U.S.C. § 119, of Italian patent application No. MI2003 A 000875, filed Apr. 30, 2003; the entire disclosure of the prior application is herewith incorporated by reference.

1. An apparatus for trimming book blocks, comprising:
a movably mounted first lateral blade holder;
a first lateral blade for performing a first lateral edge trim, said first lateral blade attached to said first lateral blade holder;
a movably mounted second lateral blade holder;
a second lateral blade for performing a second lateral edge trim, said second lateral blade attached to said second lateral blade holder; and
drives being mechanically independent of one another and each driving one of said first and second lateral blade holders.

2. The apparatus according to claim 1, further comprising at least one guide by which at least one of said first and second blade holders is guided on both sides along a movement direction, said guide contains, on both sides, at least one guide face made of a wear-resistant material.

3. The apparatus according to claim 2, wherein said wear-resistant material is PET.

4. The apparatus according to claim 2, further comprising at least one adjusting screw assigned to said at least one guide face, for changing a position of said guide face in relation to a position of an associated one of said lateral blade holders.

5. The apparatus according to claim 1, further comprising:
a drive pulley;
a blade holder housing; and
a linkage mechanism by which said first and second lateral blade holders are connected to said drives, said linkage mechanism having a movable rod, a first coupler and a second coupler, said first coupler connected to a respective one of said lateral blade holders, to said blade holder housing and, eccentrically via said movable rod, to said drive pulley, and said second coupler connected to said blade holder housing and said respective lateral blade holder, said first coupler and said second coupler configured such that a distance between a point of contact between said blade holder housing and said respective lateral blade holder is different in a case of said first and second couplers.

6. The apparatus according to claim 1, further comprising:
a drive pulley;
a blade holder housing;
a linkage mechanism connecting said first and second lateral blade holders to said drives, said linkage mechanism containing a movable rod, a first coupler and a second coupler, said first coupler connected to a respective one of said lateral blade holders, to said blade holder housing and, eccentrically via said movable rod, to said drive pulley, and said second coupler connected to said blade holder housing and said respective lateral blade holder; and
a controller for terminating a downward movement of said lateral blade holders by reversing a respective one of said drives when a predetermined cutting depth has been achieved.

7. The apparatus according to claim 1, further comprising:
a housing;
two mutually parallel guide rods fastened to said housing and having a circular cross section;
first and second blade holder housings mounted on said two mutually parallel guide rods in a horizontally displaceable manner, said first and second lateral blade holders are each movably fastened to one of said blade holder housings.

8. The apparatus according to claim 7, further comprising a further drive for displacing said blade holder housings, together with said lateral blade holders fastened to said blade holder housings, horizontally along said guide rods.

9. The apparatus according to claim 8, further comprising a threaded spindle disposed parallel to at least one of said guide rods, said threaded spindle, converting a drive movement of said further drive into a horizontal movement of said blade holder housings.

10. The apparatus according to claim 7, further comprising a controller which, in accordance with dimensions of a trimmed book block, automatically changes a position of said blade holder housings on said guide rods.

11. The apparatus according to claim 7, wherein at least one of said blade holder housings has a brake by which it is possible to fix said at least one blade holder housing on at least one of said two mutually parallel guide rods.

12. The apparatus according to claim 11, further comprising a controller which, by use of said brake, fixes said at least one blade holder housing on one of said two parallel guide rods before said lateral blade holders are vertically moved.

13. The apparatus according to claim 7, further comprising a pressing apparatus for pressing down lateral book block edges next to each of said lateral blades, said pressing apparatus for pressing down the lateral book block edges having a pressing strip and it being possible to displace said pressing apparatus for pressing down the book block edges horizontally together with said lateral blade holder housings.

14. The apparatus according to claim 13, wherein said pressing apparatus for pressing down includes:
guides connected to at least one of said blade holder housings;
toggle levers;
a common cross-member; and
rods disposed at both ends of said pressing strip, said rods are mounted vertically movably in said guides and are also connected to said common cross-member in each case via said toggle levers.

15. The apparatus according to claim 14, wherein said pressing apparatus for pressing down the book block edges has an additional drive for driving said cross-member substantially horizontally, the substantially horizontal movement being converted by said toggle levers into a vertical movement of said pressing strip.

16. The apparatus according to claim 1, further comprising:
a pressing apparatus for pressing down a book block surface between said lateral blades, said pressing apparatus for pressing down the book block surface having at least one further drive, a push rod connected to said further drive, and
a press plate connected to said push rod;
a transverse rod connected to said push rod; and
an insertion aid for changing said press plate, said insertion aid having an insertion rail which is aligned with said transverse rod during changing of said press plate.

17. The apparatus according to claim 16, wherein said press plate has an insertion rod and a coupling mechanism, into which it is possible to couple said insertion rod.

18. The apparatus according to claim 16, further comprising a magazine with a plurality of further press plates of varying dimensions.

19. The apparatus according to claim 16, further comprising an automatic press plate changer.

20. The apparatus according to claim 16, wherein:
said pressing apparatus has a press plate extension; and
said press plate has an underside with connecting elements for accommodating said press plate extension underneath said press plate.

21. The apparatus according in claim 20, wherein said press plate extension is a board which is trimmed with the same positional settings of said lateral blades for trimming the book block.

22. The apparatus according to claim 20, wherein:
said connecting elements include an adhesive surface; and
said press plate extension is a board.

23. The apparatus according to claim 1, wherein said lateral blades are interchangeable.

24. The apparatus according to claim 1, further comprising:
a movably mounted front blade holder; and
a front blade for performing a front edge trim, said front blade attached to said movably mounted front blade holder.

25. The apparatus according to claim 24, wherein at least one of said front blade and said front blade holder has the same properties as said lateral blades or said lateral blade holders, respectively.

26. The apparatus according to claim 15, wherein said additional drive is a pneumatic drive.

27. An apparatus for trimming book blocks, comprising:
a movably mounted first lateral blade holder;
a first lateral blade for performing a first lateral edge trim, said first lateral blade attached to said first lateral blade holder;
a movably mounted second lateral blade holder;
a second lateral blade for performing a second lateral edge trim, said second lateral blade attached to said second lateral blade holder; and
at least one guide by which at least one of said first and second lateral blade holders is guided on both sides along a movement direction.

28. The apparatus according to claim 27, wherein said guide contains, on both sides, at least one guide face made of a wear-resistant material.

29. The apparatus according to claim 28, wherein said wear-resistant material is PET.

30. The apparatus according to claim 28, further comprising at least one adjusting screw assigned to said at least one guide face, for changing a position of said guide face in relation to a position of an associated one of said lateral blade holders.

31. The apparatus according to claim 27, further comprising:
a drive pulley;
drives each driving one of said first and second lateral blade holders;
a blade holder housing; and
a linkage mechanism by which said first and second lateral blade holders are connected to said drives, said linkage mechanism having a movable rod, a first coupler and a second coupler, said first coupler connected to a respective one of said lateral blade holders, to said blade holder housing and, eccentrically via said movable rod, to said drive pulley, and said second coupler connected to said blade holder housing and said respective lateral blade holder, said first coupler and said second coupler configured such that a distance between a point of contact between said blade holder housing and said respective lateral blade holder is different in a case of said first and second couplers.

32. The apparatus according to claim 27, further comprising:
a drive pulley;
a blade holder housing;
drives each driving one of said first and second lateral blade holders;
a linkage mechanism connecting said first and second lateral blade holders to said drives, said linkage mechanism containing a movable rod, a first coupler and a second coupler, said first coupler connected to a respective one of said lateral blade holders, to said blade holder housing and, eccentrically via said movable rod, to said drive pulley, and said second coupler connected to said blade holder housing and said respective lateral blade holder; and
a controller for terminating a downward movement of said lateral blade holders by reversing a respective one of said drives when a predetermined cutting depth has been achieved.

33. The apparatus according to claim 27, further comprising:
a housing;
two mutually parallel guide rods fastened to said housing and having a circular cross section;
first and second blade holder housings mounted on said two mutually parallel guide rods in a horizontally displaceable manner, said first and second lateral blade holders are each movably fastened to one of said blade holder housings.

34. The apparatus according to claim 33, further comprising a drive for displacing said blade holder housings, together with said lateral blade holders fastened to said blade holder housings, horizontally along said guide rods.

35. The apparatus according to claim 34, further comprising a threaded spindle disposed parallel to at least one of said guide rods, said threaded spindle, converting a drive movement of said drive into a horizontal movement of said blade holder housings.

36. The apparatus according to claim 33, further comprising a controller which, in accordance with dimensions of a trimmed book block, automatically changes a position of said blade holder housings on said guide rods.

37. The apparatus according to claim 33, wherein at least one of said blade holder housings has a brake by which it is possible to fix said at least one blade holder housing on at least one of said two mutually parallel guide rods.

38. The apparatus according to claim 37, further comprising a controller which, by use of said brake, fixes said at least one blade holder housing on one of said two parallel guide rods before said lateral blade holders are vertically moved.

39. The apparatus according to claim 33, further comprising a pressing apparatus for pressing down lateral book block edges next to each of said lateral blades, said pressing apparatus for pressing down the lateral book block edges having a pressing strip and it being possible to displace said pressing apparatus for pressing down the book block edges horizontally together with said lateral blade holder housings.

40. The apparatus according to claim 39, wherein said pressing apparatus includes:
guides connected to at least one of said blade holder housings;
toggle levers;
a common cross-member; and
rods disposed at both ends of said pressing strip, said rods are mounted vertically movably in said guides and are also connected to said common cross-member in each case via said toggle levers.

41. The apparatus according to claim 40, wherein said pressing apparatus for pressing down the book block edges has a drive for driving said cross-member substantially horizontally, the substantially horizontal movement being converted by said toggle levers into a vertical movement of said pressing strip.

42. The apparatus according to claim 27, further comprising:
a pressing apparatus for pressing down a book block surface between said lateral blades, said pressing apparatus for pressing down the book block surface having at least one drive, a push rod connected to said drive, and a press plate connected to said push rod;
a transverse rod connected to said push rod; and
an insertion aid for changing said press plate, said insertion aid having an insertion rail which is aligned with said transverse rod during changing of said press plate.

43. The apparatus according to claim 42, wherein said press plate has an insertion rod and a coupling mechanism, into which it is possible to couple said insertion rod.

44. The apparatus according to claim 42, further comprising a magazine with a plurality of further press plates of varying dimensions.

45. The apparatus according to claim 42, further comprising an automatic press plate changer.

46. The apparatus according to claim 42, wherein:
said pressing apparatus has a press plate extension; and said press plate has an underside with connecting elements for accommodating said press plate extension underneath said press plate.

47. The apparatus according in claim 46, wherein said press plate extension is a board which is trimmed with the same positional settings of said lateral blades for trimming the book block.

48. The apparatus according to claim 46, wherein:
said connecting elements include an adhesive surface; and
said press plate extension is a board.

49. The apparatus according to claim 27, wherein said lateral blades are interchangeable.

50. The apparatus according to claim 27, further comprising:
a movably mounted front blade holder; and
a front blade for performing a front edge trim, said front blade attached to said movably mounted front blade holder.

51. The apparatus according to claim 50, wherein at least one of said front blade and said front blade holder has the same properties as said lateral blades or said lateral blade holders, respectively.

52. The apparatus according to claim 41, wherein said drive is a pneumatic drive.

53. An apparatus for trimming book blocks, comprising:
a movably mounted first lateral blade holder;
a first lateral blade for performing a first lateral edge trim, said first lateral blade attached to said first lateral blade holder;
a movably mounted second lateral blade holder;
a second lateral blade for performing a second lateral edge trim, said second lateral blade attached to said second lateral blade holder;
a blade holder housing;
a drive pulley; and
a linkage mechanism by which said first and second lateral blade holders can be connected to a drive, said linkage mechanism containing a movable rod, a first coupler, and a second coupler, said first coupler connected to a respective one of said lateral blade holders, to said blade holder housing and, eccentrically via said movable rod, to said drive pulley, and said second coupler connected to said blade holder housing and said respective lateral blade holder.

54. The apparatus according to claim 53, further comprising at least one guide by which at least one of said first and second blade holders is guided on both sides along a movement direction, said guide contains, on both sides, at least one guide face made of a wear-resistant material.

55. The apparatus according to claim 54, wherein said wear- resistant material is PET.

56. The apparatus according to claim 54, further comprising at least one adjusting screw assigned to said at least one guide face, for changing a position of said guide face in relation to a position of an associated one of said lateral blade holders.

57. The apparatus according to claim 53, wherein said first coupler and said second coupler are configured such that a distance between a point of contact between said blade holder housing and said respective lateral blade holder is different in a case of said first and second couplers.

58. The apparatus according to claim 53, further comprising:
drives each driving one of said first and second lateral blade holders; and
a controller for terminating a downward movement of said lateral blade holders by reversing a respective one of said drives when a predetermined cutting depth has been achieved.

59. The apparatus according to claim 53, further comprising:
a housing;
two mutually parallel guide rods fastened to said housing and having a circular cross section;
first and second blade holder housings mounted on said two mutually parallel guide rods in a horizontally displaceable manner, said first and second lateral blade holders are each movably fastened to one of said blade holder housings.

60. The apparatus according to claim 59, further comprising a further drive for displacing said blade holder housings, together with said lateral blade holders fastened to said blade holder housings, horizontally along said guide rods.

61. The apparatus according to claim 60, further comprising a threaded spindle disposed parallel to at least one of said guide rods, said threaded spindle, converting a drive movement of said further drive into a horizontal movement of said blade holder housings.

62. The apparatus according to claim 59, further comprising a controller which, in accordance with dimensions of a trimmed book block, automatically changes a position of said blade holder housings on said guide rods.

63. The apparatus according to claim 59, wherein at least one of said blade holder housings has a brake by which it is possible to fix said at least one blade holder housing on at least one of said two mutually parallel guide rods.

64. The apparatus according to claim 63, further comprising a controller which, by use of said brake, fixes said at least one blade holder housing on one of said two parallel guide rods before said lateral blade holders are vertically moved.

65. The apparatus according to claim 59, further comprising a pressing apparatus for pressing down lateral book block edges next to each of said lateral blades, said pressing apparatus for pressing down the lateral book block edges having a pressing strip and it being possible to displace said pressing apparatus for pressing down the book block edges horizontally together with said lateral blade holder housings.

66. The apparatus according to claim 65, wherein said pressing apparatus for pressing down includes:
guides connected to at least one of said blade holder housings;
toggle levers;
a common cross-member; and
rods disposed at both ends of said pressing strip, said rods are mounted vertically movably in said guides and are also connected to said common cross-member in each case via said toggle levers.

67. The apparatus according to claim 66, wherein said pressing apparatus for pressing down the book block edges has an additional drive for driving said cross-member substantially horizontally, the substantially horizontal movement being converted by said toggle levers into a vertical movement of said pressing strip.

68. The apparatus according to claim 53, further comprising:
a pressing apparatus for pressing down a book block surface between said lateral blades, said pressing apparatus for pressing down the book block surface having at least one further drive, a push rod connected to said further drive, and a press plate connected to said push rod;
a transverse rod connected to said push rod; and
an insertion aid for changing said press plate, said insertion aid having an insertion rail which is aligned with said transverse rod during changing of said press plate.

69. The apparatus according to claim 68, wherein said press plate has an insertion rod and a coupling mechanism, into which it is possible to couple said insertion rod.

70. The apparatus according to claim 68, further comprising a magazine with a plurality of further press plates of varying dimensions.

71. The apparatus according to claim 68, further comprising an automatic press plate changer.

72. The apparatus according to claim 68, wherein:
said pressing apparatus has a press plate extension; and
said press plate has an underside with connecting elements for accommodating said press plate extension underneath said press plate.

73. The apparatus according in claim 72, wherein said press plate extension is a board which is trimmed with the same positional settings of said lateral blades for trimming the book block.

74. The apparatus according to claim 72, wherein:
said connecting elements include an adhesive surface; and
said press plate extension is a board.

75. The apparatus according to claim 53, wherein said lateral blades are interchangeable.

76. The apparatus according to claim 53, further comprising:
a movably mounted front blade holder; and
a front blade for performing a front edge trim, said front blade attached to said movably mounted front blade holder.

77. The apparatus according to claim 76, wherein at least one of said front blade and said front blade holder has the same properties as said lateral blades or said lateral blade holders, respectively.

78. The apparatus according to claim 67, wherein said additional drive is a pneumatic drive.

79. An apparatus for trimming book blocks, the apparatus comprising:
a movably mounted first lateral blade holder;
a first lateral blade for performing a first lateral edge trim, said first lateral blade attached to said first lateral blade holder;
a movably mounted second lateral blade holder;
a second lateral blade for performing a second lateral edge trim, said second lateral blade attached to said second lateral blade holder; and
a controller, said first and second lateral blade holders being driven and mounted for switching off a movement of at least one of said first and second lateral blade holders by said controller.

80. The apparatus according to claim 79, further comprising at least one guide by which at least one of said first and second blade holders is guided on both sides along a movement direction, said guide contains, on both sides, at least one guide face made of a wear-resistant material.

81. The apparatus according to claim 80, wherein said wear-resistant material is PET.

82. The apparatus according to claim 80, further comprising at least one adjusting screw assigned to said at least one guide face, for changing a position of said guide face in relation to a position of an associated one of said lateral blade holders.

83. The apparatus according to claim 79, further comprising:
a drive pulley;
drives each driving one of said first and second lateral blade holders;
a blade holder housing; and
a linkage mechanism by which said first and second lateral blade holders are connected to said drives, said linkage mechanism having a movable rod, a first coupler and a second coupler, said first coupler connected to a respective one of said lateral blade holders, to said blade holder housing and, eccentrically via said movable rod, to said drive pulley, and said second coupler connected to said blade holder housing and said respective lateral blade holder, said first coupler and said second coupler configured such that a distance between a point of contact between said blade holder housing and said respective lateral blade holder is different in a case of said first and second couplers.

84. The apparatus according to claim 79, further comprising:
a drive pulley;
a blade holder housing;
drives each driving one of said first and second lateral blade holders; and
a linkage mechanism connecting said first and second lateral blade holders to said drives, said linkage mechanism containing a movable rod, a first coupler and a second coupler, said first coupler connected to a respective one of said lateral blade holders, to said blade holder housing and, eccentrically via said movable rod, to said drive pulley, and said second coupler connected to said blade holder housing and said respective lateral blade holder;
said controller terminating a downward movement of said lateral blade holders by reversing a respective one of said drives when a predetermined cutting depth has been achieved.

85. The apparatus according to claim 79, further comprising:
a housing;
two mutually parallel guide rods fastened to said housing and having a circular cross section;
first and second blade holder housings mounted on said two mutually parallel guide rods in a horizontally displaceable manner, said first and second lateral blade holders are each movably fastened to one of said blade holder housings.

86. The apparatus according to claim 85, further comprising a drive for displacing said blade holder housings, together with said lateral blade holders fastened to said blade holder housings, horizontally along said guide rods.

87. The apparatus according to claim 86, further comprising a threaded spindle disposed parallel to at least one of said guide rods, said threaded spindle, converting a drive movement of said drive into a horizontal movement of said blade holder housings.

88. The apparatus according to claim 85, wherein said controller which, in accordance with dimensions of a trimmed book block, automatically changes a position of said blade holder housings on said guide rods.

89. The apparatus according to claim 85, wherein at least one of said blade holder housings has a brake by which it is possible to fix said at least one blade holder housing on at least one of said two mutually parallel guide rods.

90. The apparatus according to claim 89, further wherein said controller which, by use of said brake, fixes said at least one blade holder housing on one of said two parallel guide rods before said lateral blade holders are vertically moved.

91. The apparatus according to claim 85, further comprising a pressing apparatus for pressing down lateral book block edges next to each of said lateral blades, said pressing apparatus for pressing down the lateral book block edges having a pressing strip and it being possible to displace said pressing apparatus for pressing down the book block edges horizontally together with said lateral blade holder housings.

92. The apparatus according to claim 91, wherein said pressing apparatus for pressing down includes:
guides connected to at least one of said blade holder housings;
toggle levers;
a common cross-member; and
rods disposed at both ends of said pressing strip, said rods are mounted vertically movably in said guides and are also connected to said common cross-member in each case via said toggle levers.

93. The apparatus according to claim 92, wherein said pressing apparatus for pressing down the book block edges has an additional drive for driving said cross-member substantially horizontally, the substantially horizontal movement being converted by said toggle levers into a vertical movement of said pressing strip.

94. The apparatus according to claim 79, further comprising:
a pressing apparatus for pressing down a book block surface between said lateral blades, said pressing apparatus for pressing down the book block surface having at least one further drive, a push rod connected to said further drive, and
a press plate connected to said push rod;
a transverse rod connected to said push rod; and
an insertion aid for changing said press plate, said insertion aid having an insertion rail which is aligned with said transverse rod during changing of said press plate.

95. The apparatus according to claim 94, wherein said press plate has an insertion rod and a coupling mechanism, into which it is possible to couple said insertion rod.

96. The apparatus according to claim 94, further comprising a magazine with a plurality of further press plates of varying dimensions.

97. The apparatus according to claim 94, further comprising an automatic press plate changer.

98. The apparatus according to claim 94, wherein:
said pressing apparatus has a press plate extension; and
said press plate has an underside with connecting elements for accommodating said press plate extension underneath said press plate.

99. The apparatus according in claim 98, wherein said press plate extension is a board which is trimmed with the same positional settings of said lateral blades for trimming the book block.

100. The apparatus according to claim 98, wherein:
said connecting elements include an adhesive surface; and
said press plate extension is a board.

101. The apparatus according to claim 79, wherein said lateral blades are interchangeable.

102. The apparatus according to claim 79, further comprising:
a movably mounted front blade holder; and
a front blade for performing a front edge trim, said front blade attached to said movably mounted front blade holder.

103. The apparatus according to claim 102, wherein at least one of said front blade and said front blade holder has the same properties as said lateral blades or said lateral blade holders, respectively.

104. The apparatus according to claim 93, wherein said additional drive is a pneumatic drive.

105. An apparatus for trimming book blocks, comprising:
a housing;
two mutually parallel guide rods fastened to said housing and having a circular cross section;
first and second blade holder housings mounted on said two mutually parallel guide rods in a horizontally displaceable manner;
a first lateral blade holder movably fastened to said first blade holder housing;
a first lateral blade for performing a first lateral edge trim, said first lateral blade attached to said first lateral blade holder;
a second lateral blade holder movably fastened to said second blade holder housing; and
a second lateral blade for performing a second lateral edge trim, said second lateral blade attached to said second lateral blade holder.

106. The apparatus according to claim 105, further comprising at least one guide by which at least one of said first and second blade holders is guided on both sides along a movement direction, said guide contains, on both sides, at least one guide face made of a wear-resistant material.

107. The apparatus according to claim 106, wherein said wear-resistant material is PET.

108. The apparatus according to claim 106, further comprising at least one adjusting screw assigned to said at least one guide face, for changing a position of said guide face in relation to a position of an associated one of said lateral blade holders.

109. The apparatus according to claim 105, further comprising:
a drive pulley;
drives each driving one of said first and second lateral blade holders;
a linkage mechanism by which said first and second lateral blade holders are connected to said drives, said linkage mechanism having a movable rod, a first coupler and a second coupler, said first coupler connected to a respective one of said lateral blade holders, to a respective one of said blade holder housings and, eccentrically via said movable rod, to said drive pulley, and said second coupler connected to said respective blade holder housing and said respective lateral blade holder, said first coupler and said second coupler configured such that a distance between a point of contact between said respective blade holder housing and said respective lateral blade holder is different in a case of said first and second couplers.

110. The apparatus according to claim 105, further comprising:
a drive pulley;
drives each driving one of said first and second lateral blade holders;
a linkage mechanism connecting said first and second lateral blade holders to said drives, said linkage mechanism containing a movable rod, a first coupler and a second coupler, said first coupler connected to a respective one of said lateral blade holders, to a respective one of said blade holder housings and, eccentrically via said movable rod, to said drive pulley, and said second coupler connected to said respective blade holder housing and said respective lateral blade holder; and
a controller for terminating a downward movement of said lateral blade holders by reversing a respective one of said drives when a predetermined cutting depth has been achieved.

111. The apparatus according to claim 105, further comprising a drive for displacing said blade holder housings, together with said lateral blade holders fastened to said blade holder housings, horizontally along said guide rods.

112. The apparatus according to claim 111, further comprising a threaded spindle disposed parallel to at least one of said guide rods, said threaded spindle, converting a drive movement of said drive into a horizontal movement of said blade holder housings.

113. The apparatus according to claim 110, further comprising a controller which, in accordance with dimensions of a trimmed book block, automatically changes a position of said blade holder housings on said guide rods.

114. The apparatus according to claim 110, wherein at least one of said blade holder housings has a brake by which it is possible to fix said at least one blade holder housing on at least one of said two mutually parallel guide rods.

115. The apparatus according to claim 114, further comprising a controller which, by use of said brake, fixes said at least one blade holder housing on one of said two parallel guide rods before said lateral blade holders are vertically moved.

116. The apparatus according to claim 110, further comprising a pressing apparatus for pressing down lateral book block edges next to each of said lateral blades, said pressing apparatus for pressing down the lateral book block edges having a pressing strip and it being possible to displace said pressing apparatus for pressing down the book block edges horizontally together with said lateral blade holder housings.

117. The apparatus according to claim 116, wherein said pressing apparatus for pressing down includes:
guides connected to at least one of said blade holder housings;
toggle levers;
a common cross-member; and
rods disposed at both ends of said pressing strip, said rods are mounted vertically movably in said guides and are also connected to said common cross-member in each case via said toggle levers.

118. The apparatus according to claim 117, wherein said pressing apparatus for pressing down the book block edges has an additional drive for driving said cross-member substantially horizontally, the substantially horizontal movement being converted by said toggle levers into a vertical movement of said pressing strip.

119. The apparatus according to claim 105, further comprising:
a pressing apparatus for pressing down a book block surface between said lateral blades, said pressing apparatus for pressing down the book block surface having at least one further drive, a push rod connected to said further drive, and
a press plate connected to said push rod;
a transverse rod connected to said push rod; and
an insertion aid for changing said press plate, said insertion aid having an insertion rail which is aligned with said transverse rod during changing of said press plate.

120. The apparatus according to claim 119, wherein said press plate has an insertion rod and a coupling mechanism, into which it is possible to couple said insertion rod.

121. The apparatus according to claim 119, further comprising a magazine with a plurality of further press plates of varying dimensions.

122. The apparatus according to claim 119, further comprising an automatic press plate changer.

123. The apparatus according to claim 119, wherein:
said pressing apparatus has a press plate extension; and
said press plate has an underside with connecting elements for accommodating said press plate extension underneath said press plate.

124. The apparatus according in claim 123, wherein said press plate extension is a board which is trimmed with the same positional settings of said lateral blades for trimming the book block.

125. The apparatus according to claim 123, wherein:
said connecting elements include an adhesive surface; and
said press plate extension is a board.

126. The apparatus according to claim 105, wherein said lateral blades are interchangeable.

127. The apparatus according to claim 105, further comprising:
a movably mounted front blade holder; and
a front blade for performing a front edge trim, said front blade attached to said movably mounted front blade holder.

128. The apparatus according to claim 127, wherein at least one of said front blade and said front blade holder has the same properties as said lateral blades or said lateral blade holders, respectively.

129. The apparatus according to claim 118, wherein said additional drive is a pneumatic drive.

130. An apparatus for trimming book blocks, comprising:
a movably mounted first lateral blade holder;
a first lateral blade for performing a first lateral edge trim, said first lateral blade attached to said first lateral blade holder;
a movably mounted second lateral blade holder;
a second lateral blade for performing a second lateral edge trim, said second lateral blade attached to said second lateral blade holder;
a blade holder housing; and
a pressing apparatus for pressing down lateral book block edges next to each of said first and second lateral blades, said pressing apparatus having a pressing strip, said pressing apparatus being movably fastened to said lateral blade holder housing.

131. The apparatus according to claim 129, further comprising at least one guide by which at least one of said first and second blade holders is guided on both sides along a movement direction, said guide contains, on both sides, at least one guide face made of a wear-resistant material.

132. The apparatus according to claim 131, wherein said wear-resistant material is PET.

133. The apparatus according to claim 131, further comprising at least one adjusting screw assigned to said at least one guide face, for changing a position of said guide face in relation to a position of an associated one of said lateral blade holders.

134. The apparatus according to claim 129, further comprising:
a drive pulley;
drives each driving one of said first and second lateral blade holders; and
a linkage mechanism by which said first and second lateral blade holders are connected to said drives, said linkage mechanism having a movable rod, a first coupler and a second coupler, said first coupler connected to a respective one of said lateral blade holders, to said blade holder housing and, eccentrically via said movable rod, to said drive pulley, and said second coupler connected to said blade holder housing and said respective lateral blade holder, said first coupler and said second coupler configured such that a distance between a point of contact between said blade holder housing and said respective lateral blade holder is different in a case of said first and second couplers.

135. The apparatus according to claim 129, further comprising:
a drive pulley;
drives each driving one of said first and second lateral blade holders;
a blade holder housing;
a linkage mechanism connecting said first and second lateral blade holders to said drives, said linkage mechanism containing a movable rod, a first coupler and a second coupler, said first coupler connected to a respective one of said lateral blade holders, to said blade holder housing and, eccentrically via said movable rod, to said drive pulley, and said second coupler connected to said blade holder housing and said respective lateral blade holder; and
a controller for terminating a downward movement of said lateral blade holders by reversing a respective one of said drives when a predetermined cutting depth has been achieved.

136. The apparatus according to claim 129, further comprising:
a housing;
two mutually parallel guide rods fastened to said housing and having a circular cross section;
said blade holder housing including first and second blade holder housings mounted on said two mutually parallel guide rods in a horizontally displaceable manner, said first and second lateral blade holders are each movably fastened to one of said blade holder housings.

137. The apparatus according to claim 136, further comprising a drive for displacing said blade holder housings, together with said lateral blade holders fastened to said blade holder housings, horizontally along said guide rods.

138. The apparatus according to claim 137, further comprising a threaded spindle disposed parallel to at least one of said guide rods, said threaded spindle, converting a drive movement of said drive into a horizontal movement of said blade holder housings.

139. The apparatus according to claim 136, further comprising a controller which, in accordance with dimensions of a trimmed book block, automatically changes a position of said blade holder housings on said guide rods.

140. The apparatus according to claim 136, wherein at least one of said blade holder housings has a brake by which it is possible to fix said at least one blade holder housing on at least one of said two mutually parallel guide rods.

141. The apparatus according to claim 140, further comprising a controller which, by use of said brake, fixes said at least one blade holder housing on one of said two parallel guide rods before said lateral blade holders are vertically moved.

142. The apparatus according to claim 136, wherein said pressing apparatus together with said lateral blade holder housings are movable in a horizontal direction.

143. The apparatus according to claim 142, wherein said pressing apparatus includes:
guides connected to at least one of said blade holder housings;
toggle levers;
a common cross-member; and
rods disposed at both ends of said pressing strip, said rods are mounted vertically movably in said guides and are also connected to said common cross-member in each case via said toggle levers.

144. The apparatus according to claim 143, wherein said pressing apparatus has a drive for driving said cross-member substantially horizontally, the substantially horizontal movement being converted by said toggle levers into a vertical movement of said pressing strip.

145. The apparatus according to claim 129, further comprising:
a further pressing apparatus for pressing down a book block surface between said lateral blades, said further pressing apparatus having at least drive, a push rod connected to said drive, and a press plate connected to said push rod;
a transverse rod connected to said push rod; and
an insertion aid for changing said press plate, said insertion aid having an insertion rail which is aligned with said transverse rod during changing of said press plate.

146. The apparatus according to claim 145, wherein said press plate has an insertion rod and a coupling mechanism, into which it is possible to couple said insertion rod.

147. The apparatus according to claim 145, further comprising a magazine with a plurality of further press plates of varying dimensions.

148. The apparatus according to claim 145, further comprising an automatic press plate changer.

149. The apparatus according to claim 145, wherein:
said further pressing apparatus has a press plate extension; and
said press plate has an underside with connecting elements for accommodating said press plate extension underneath said press plate.

150. The apparatus according in claim 149, wherein said press plate extension is a board which is trimmed with the same positional settings of said lateral blades for trimming the book block.

151. The apparatus according to claim 149, wherein:
said connecting elements include an adhesive surface; and
said press plate extension is a board.

152. The apparatus according to claim 129, wherein said lateral blades are interchangeable.

153. The apparatus according to claim 129, further comprising:
a movably mounted front blade holder; and
a front blade for performing a front edge trim, said front blade attached to said movably mounted front blade holder.

154. The apparatus according to claim 153, wherein at least one of said front blade and said front blade holder has the same properties as said lateral blades or said lateral blade holders, respectively.

155. The apparatus according to claim 144, wherein said drive is a pneumatic drive.

156. An apparatus for trimming book blocks, comprising:
a movably mounted first lateral blade holder;
a first lateral blade for performing a first lateral edge trim, said first lateral blade attached to said first lateral blade holder;
a movably mount second lateral blade holder;
a second lateral blade for performing a second lateral edge trim, said second lateral blade attached to said second lateral blade holder; and
a pressing apparatus for pressing down a book block surface between said first and second lateral blades, said pressing apparatus having at least one drive, a push rod connected to said drive, and a press plate connected to said push rod, said pressing apparatus additionally having a transverse rod disposed vertically on said push rod and parallel to said first and second lateral blades, and connecting elements by which said press plate latches releasably to said push rod.

157. The apparatus according to claim 156, further comprising at least one guide by which at least one of said first and second blade holders is guided on both sides along a movement direction, said guide contains, on both sides, at least one guide face made of a wear-resistant material.

158. The apparatus according to claim 157, wherein said wear-resistant material is PET.

159. The apparatus according to claim 157, further comprising at least one adjusting screw assigned to said at least one guide face, for changing a position of said guide face in relation to a position of an associated one of said lateral blade holders.

160. The apparatus according to claim 156, further comprising:
a drive pulley;
further drives each driving one of said first and second lateral blade holders;
a blade holder housing; and
a linkage mechanism by which said first and second lateral blade holders are connected to said further drives, said linkage mechanism having a movable rod, a first coupler and a second coupler, said first coupler connected to a respective one of said lateral blade holders, to said blade holder housing and, eccentrically via said movable rod, to said drive pulley, and said second coupler connected to said blade holder housing and said respective lateral blade holder, said first coupler and said second coupler configured such that a distance between a point of contact between said blade holder housing and said respective lateral blade holder is different in a case of said first and second couplers.

161. The apparatus according to claim 156, further comprising:
a drive pulley;
further drives each driving one of said first and second lateral blade holders;
a blade holder housing;
a linkage mechanism connecting said first and second lateral blade holders to said further drives, said linkage mechanism containing a movable rod, a first coupler and a second coupler, said first coupler connected to a respective one of said lateral blade holders, to said blade holder housing and, eccentrically via said movable rod, to said drive pulley, and said second coupler connected to said blade holder housing and said respective lateral blade holder; and
a controller for terminating a downward movement of said lateral blade holders by reversing a respective one of said further drives when a predetermined cutting depth has been achieved.

162. The apparatus according to claim 156, further comprising:
a housing;
two mutually parallel guide rods fastened to said housing and having a circular cross section;
first and second blade holder housings mounted on said two mutually parallel guide rods in a horizontally displaceable manner, said first and second lateral blade holders are each movably fastened to one of said blade holder housings.

163. The apparatus according to claim 162, further comprising a further drive for displacing said blade holder housings, together with said lateral blade holders fastened to said blade holder housings, horizontally along said guide rods.

164. The apparatus according to claim 163, further comprising a threaded spindle disposed parallel to at least one of said guide rods, said threaded spindle, converting a drive movement of said further drive into a horizontal movement of said blade holder housings.

165. The apparatus according to claim 162, further comprising a controller which, in accordance with dimensions of a trimmed book block, automatically changes a position of said blade holder housings on said guide rods.

166. The apparatus according to claim 162, wherein at least one of said blade holder housings has a brake by which it is possible to fix said at least one blade holder housing on at least one of said two mutually parallel guide rods.

167. The apparatus according to claim 166, further comprising a controller which, by use of said brake, fixes said at least one blade holder housing on one of said two parallel guide rods before said lateral blade holders are vertically moved.

168. The apparatus according to claim 162, further comprising a further pressing apparatus for pressing down lateral book block edges next to each of said lateral blades, said further pressing apparatus for pressing down the lateral book block edges having a pressing strip and it being possible to displace said further pressing apparatus for pressing down the book block edges horizontally together with said lateral blade holder housings.

169. The apparatus according to claim 168, wherein said further pressing apparatus:
guides connected to at least one of said blade holder housings;
toggle levers;
a common cross-member; and
rods disposed at both ends of said pressing strip, said rods are mounted vertically movably in said guides and are also connected to said common cross-member in each case via said toggle levers.

170. The apparatus according to claim 169, wherein said further pressing apparatus for pressing down the book block edges has an additional drive for driving said cross-member substantially horizontally, the substantially horizontal movement being converted by said toggle levers into a vertical movement of said pressing strip.

171. The apparatus according to claim 156, wherein said pressing apparatus having an insertion aid for changing said press plate, said insertion aid having an insertion rail which is aligned with said transverse rod during changing of said press plate.

172. The apparatus according to claim 171, wherein said press plate has an insertion rod and a coupling mechanism, into which it is possible to couple said insertion rod.

173. The apparatus according to claim 171, further comprising a magazine with a plurality of further press plates of varying dimensions.

174. The apparatus according to claim 171, further comprising an automatic press plate changer.

175. The apparatus according to claim 171, wherein:
said pressing apparatus has a press plate extension; and
said press plate has an underside with connecting elements for accommodating said press plate extension underneath said press plate.

176. The apparatus according in claim 175, wherein said press plate extension is a board which is trimmed with the same positional settings of said lateral blades for trimming the book block.

177. The apparatus according to claim 175, wherein:
said connecting elements include an adhesive surface; and
said press plate extension is a board.

178. The apparatus according to claim 156, wherein said lateral blades are interchangeable.

179. The apparatus according to claim 156, further comprising:
a movably mounted front blade holder; and
a front blade for performing a front edge trim, said front blade attached to said movably mounted front blade holder.

180. The apparatus according to claim 179, wherein at least one of said front blade and said front blade holder has the same properties as said lateral blades or said lateral blade holders, respectively.

181. The apparatus according to claim 170, wherein said additional drive is a pneumatic drive.

182. A method for setting up an apparatus for trimming book blocks, which comprises the steps of:
moving a blade holder into a blade change position above a zero position of the blade holder;
loosely hooking a blade into the blade holder;
lowering the blade holder into the zero position of the blade holder;
lowering the blade onto a cutting base defining the zero position of the blade; and
fixing the blade in the zero position of the blade.

183. The method according claim 182, which further comprises:
correcting the zero position of the blade by displacing the zero position of the blade holder by control technology.

184. The method according to claim 182, which further comprises:
fastening change handles to the blade prior to performing the loosely hooking step.

185. The method according to claim 182, which further comprises repeating all of the steps individually for each blade of the apparatus.
